(19) United States
(12) Patent Application Publication
(10) Pub. No.: US 2016/0053891 A1
(43) Pub. Date: Feb. 25, 2016

(54) COMPRESSOR HEAD AND GASKET FOR SAME

(71) Applicant: Bendix Commercial Vehicle Systems LLC, Elyria, OH (US)

(72) Inventors: Padraig B. Yeats, Avon Lake, OH (US); Jeffrey M. Geither, North Ridgeville, OH (US); Larry E. Dienes, North Ridgeville, OH (US)

(21) Appl. No.: 14/463,207

(22) Filed: Aug. 19, 2014

(51) Int. Cl. F16J 15/08; F04B 39/12; F04B 53/00; F16J 15/06

(52) U.S. Cl. CPC F16J 15/0818; F16J 15/061; F16J 15/064; F04B 39/125; F04B 53/001; F16J 2015/0856; F05B 2240/57; F05B 2260/96

(57) ABSTRACT

A compressor head includes an upper part, a lower part, a baffle, and a gasket between the upper part and the lower part. The gasket includes an inner perimeter portion between, and substantially delineating, an upper inner mating portion and a lower inner mating portion of the compressor head. The gasket also includes an outer perimeter portion between, and substantially delineating, an upper outer mating portion and a lower outer mating portion of the compressor head. A tab extends toward the first volume in the compressor head from the inner perimeter portion. The tab cooperates with an upper ledge and a lower ledge of the compressor head to reduce vibration of the baffle between the upper part and the lower part.

### BACKGROUND

The present invention relates to a compressor head. It finds particular application in conjunction with including a gasket and will be described with particular reference thereto. It will be appreciated, however, that the invention is also amenable to other applications.

Heavy vehicles commonly include a compressor for generating compressed air to run system components (e.g., air brakes) on the vehicle. Compressing air in a cylinder head can create a substantial amount of heat, which may be considered excessive if the heat is transmitted to other components (e.g., an air dryer) on the vehicle. For example, it is not uncommon for compressed air to be discharged to an air dryer for conditioning the compressed air before being used in other vehicle systems such as the air brakes. Compressed air discharged from the compressor head may be heated above a desirable temperature for the air dryer. Furthermore, the heat tends to reduce the useful life of the cylinder head and the parts therein. For example, gaskets and seals in the cylinder head tend to degrade more quickly when exposed to heat. Therefore, reducing heat in a cylinder head can extend the life of the cylinder head and other components to which the compressed air is discharged.

Some cylinder head assemblies are made up of two mating halves. One known method for improving heat transfer and lowering discharge air temperatures of such cylinder head assemblies is to use a dividing plate, which extends the full width and length of the cylinder head assembly, as an air baffle to double the discharge air velocity through the head. This design requires the use of two gaskets to allow the sealing of the upper cylinder head half and the lower cylinder head half to the air baffle. Because the air baffle is also a gasket sealing surface, the surface flatness and surface finish of the air baffle is controlled to reduce air and coolant leaks. The controlled flatness and surface finish, along with the size of the dividing baffle plate, contributes to its expense. Also, the use of multiple gaskets tends to cause additional warranty issues through coolant or air leaks since more gaskets offer more opportunities for seal failures.

The present invention provides a new and improved compressor head and gasket and method of manufacturing same.

### SUMMARY

In one embodiment, a compressor head includes an upper part, a lower part, an air baffle, and a gasket between the upper part and the lower part. The gasket includes an inner perimeter portion between, and substantially delineating, an upper inner mating portion and a lower inner mating portion of the compressor head. The gasket also includes an outer perimeter portion between, and substantially delineating, an upper outer mating portion and a lower outer mating portion of the compressor head. A tab extends toward the first volume in the compressor head from the inner perimeter portion. The tab cooperates with an upper ledge and a lower ledge of the compressor head to reduce vibration of the air baffle between the upper part and the lower part.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a perspective view of a compressor head in accordance with one embodiment of an apparatus illustrating principles of the present invention;

FIG. 2 illustrates an exploded representation of the compressor head in accordance with one embodiment of an apparatus illustrating principles of the present invention;

FIG. 3 illustrates a bottom view of a top portion of the compressor head in accordance with one embodiment of an apparatus illustrating principles of the present invention;

FIG. 4 illustrates a top view of a bottom portion of the compressor head in accordance with one embodiment of an apparatus illustrating principles of the present invention;

FIG. 5 illustrates a top view of the bottom portion of the compressor head and a baffle in accordance with one embodiment of an apparatus illustrating principles of the present invention;

FIG. 6 illustrates a top view of the bottom portion of the compressor head, the baffle, and a gasket in accordance with one embodiment of an apparatus illustrating principles of the present invention;

FIG. 7 illustrates a projection of the gasket in accordance with one embodiment of an apparatus illustrating principles of the present invention;

FIG. 8 is an exemplary methodology of manufacturing the compressor head in accordance with one embodiment illustrating principles of the present invention; and

FIG. 9 is an exemplary methodology of a fluid passing through a second volume of the compressor head in accordance with one embodiment illustrating principles of the present invention.

### DETAILED DESCRIPTION OF ILLUSTRATED EMBODIMENT

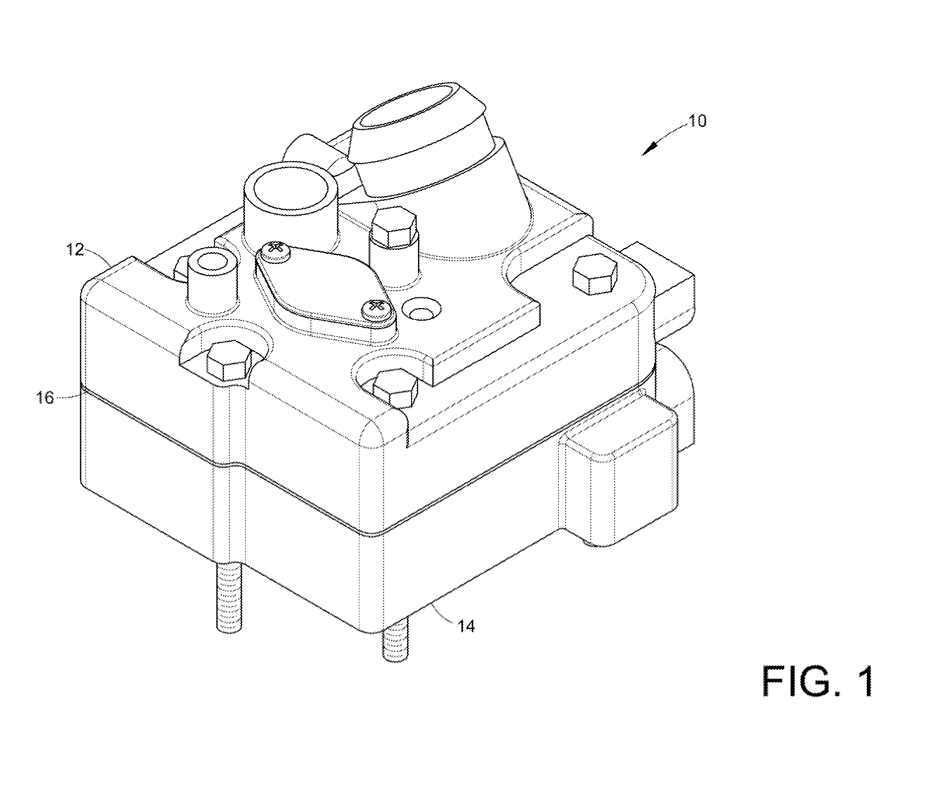

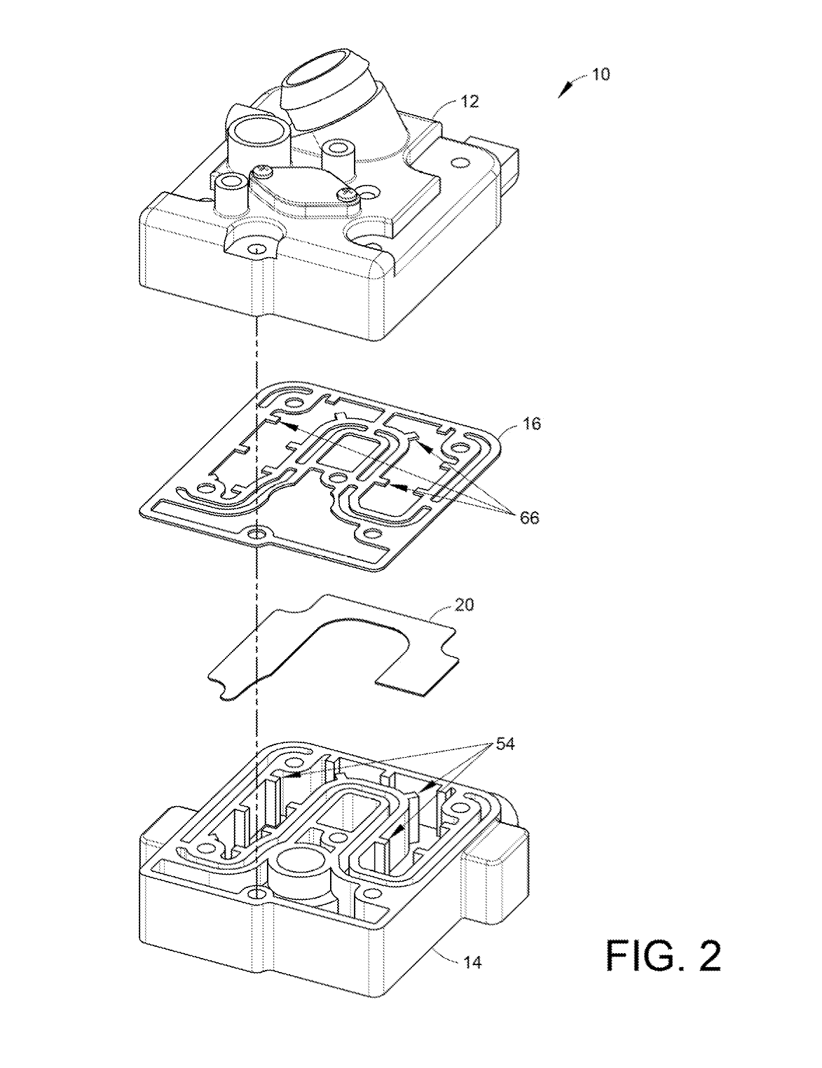

With reference to FIGS. 1 and 2, a simplified exploded diagram of an exemplary compressor head 10 is illustrated in accordance with one embodiment of the present invention. The compressor head 10 includes an upper portion 12 (e.g., upper part) and a lower portion 14 (e.g., lower part). A sealing device 16 (e.g., a gasket) is positioned between the upper portion 12 and the lower portion 14 of the compressor head 10. A baffle 20 (e.g., an air baffle) is also positioned between the upper portion 12 and the lower portion 14 of the compressor head 10. In the illustrated embodiment, the baffle 20 is between the gasket 16 and the lower portion 14 of the compressor head 10.

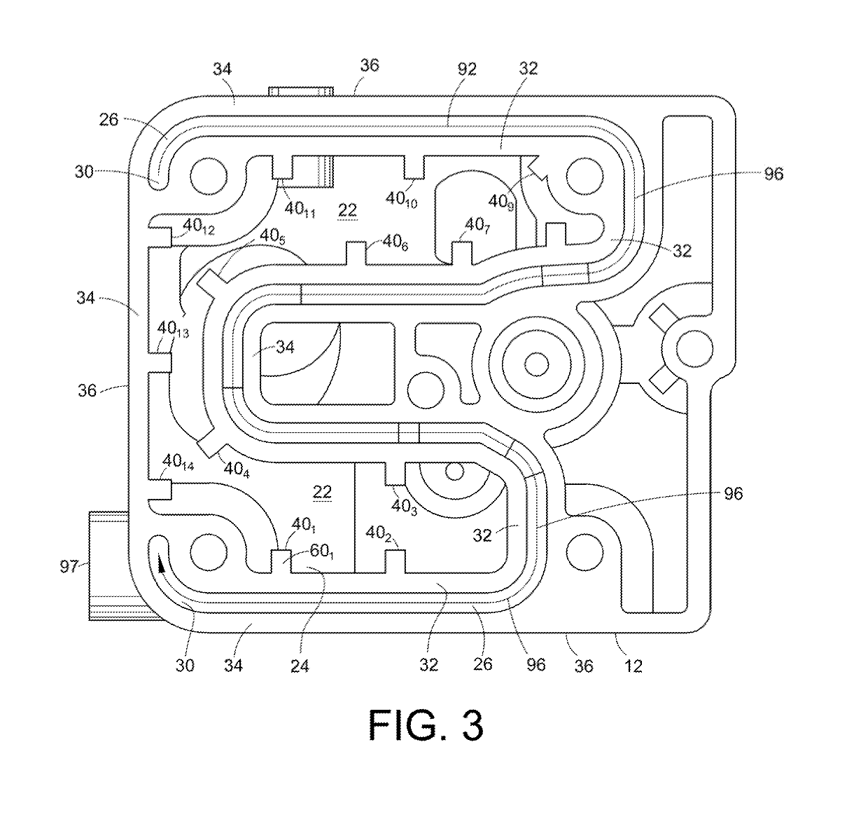

With reference to FIG. 3, the upper portion 12 includes an upper portion 22 of a first volume 24 and an upper portion 26 of a second volume 30.

An upper inner mating portion 32 (upper inner shelf) defines parts of the upper portion 22 of the first volume 24 and the upper portion 26 of the second volume 30. An upper outer mating portion 34 (upper outer shelf) also defines parts of the upper portion 22 of the first volume 24 and the upper portion 26 of the second volume 30. The upper outer mating portion 34 is proximate to an upper outer perimeter 36 of the upper portion 12.

At least one upper ledge 40 extends into the upper portion 22 of the first volume 24. In the illustrated embodiment, the at least one upper ledge 40 includes fourteen (14) upper ledges 40₁, 40₂, 40₃, 40₄, 40₅, 40₆, 40₇, 40₈, 40₉, 40₁₀, 40₁₁, 40₁₂, 40₁₃, 40₁₄ (collectively, 40). The upper ledges 40₁₋₁₁ are positioned along the upper inner mating portion 32, and the upper ledges 40₁₂₋₁₄ are positioned along the upper outer mating portion 34.

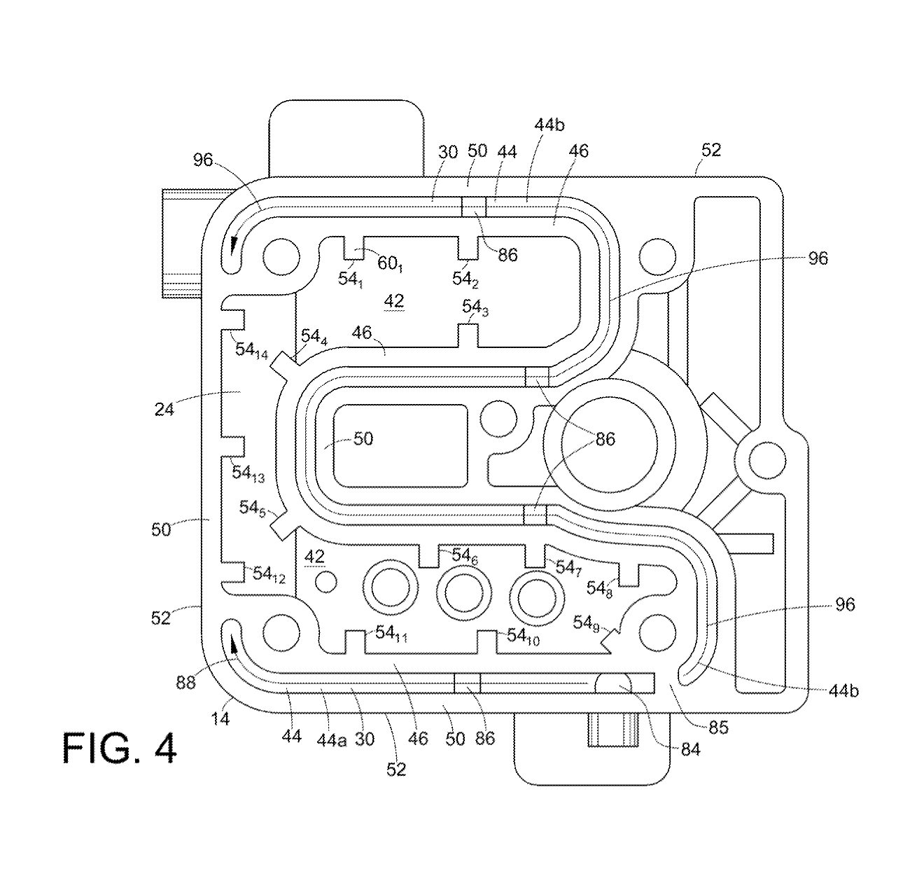

With reference to FIG. 4, the lower portion 14 includes a lower portion 42 of the first volume 24 and a lower portion 44 of the second volume 30.

A lower inner mating portion 46 (lower inner shelf) defines parts of the lower portion 42 of the first volume 24 and the lower portion 44 of the second volume 30. A lower outer mating portion 50 (lower outer shelf) also defines parts of the lower portion 42 of the first volume 24 and the lower portion 44 of the second volume 30. The lower outer mating portion 50 is proximate to a lower outer perimeter 52 of the lower portion 14.

At least one lower ledge 54 extends into the lower portion 42 of the first volume 24. In the illustrated embodiment, the at least one lower ledge 54 includes fourteen (14) lower ledges 54₁, 54₂, 54₃, 54₄, 54₅, 54₆, 54₇, 54₈, 54₉, 54₁₀, 54₁₁, 54₁₂, 54₁₃, 54₁₄ (collectively, 54). The lower ledges 54₁₋₁₁ are positioned along the lower inner mating portion 46, and the lower ledges 54₁₂₋₁₄ are positioned along the lower outer mating portion 50.

In one embodiment, each of the lower ledges 54 is substantially aligned with a respective one of the upper ledges 40. In other words, when the lower portion 14 of the compressor head 10 is substantially aligned with the upper portion 12 of the compressor head 10, respective lower faces 56 of the lower ledges 54 are substantially aligned with respective upper faces 60 of the upper ledges 40. For ease of illustration, only the lower face 56₁ and upper face 60₁ are illustrated.

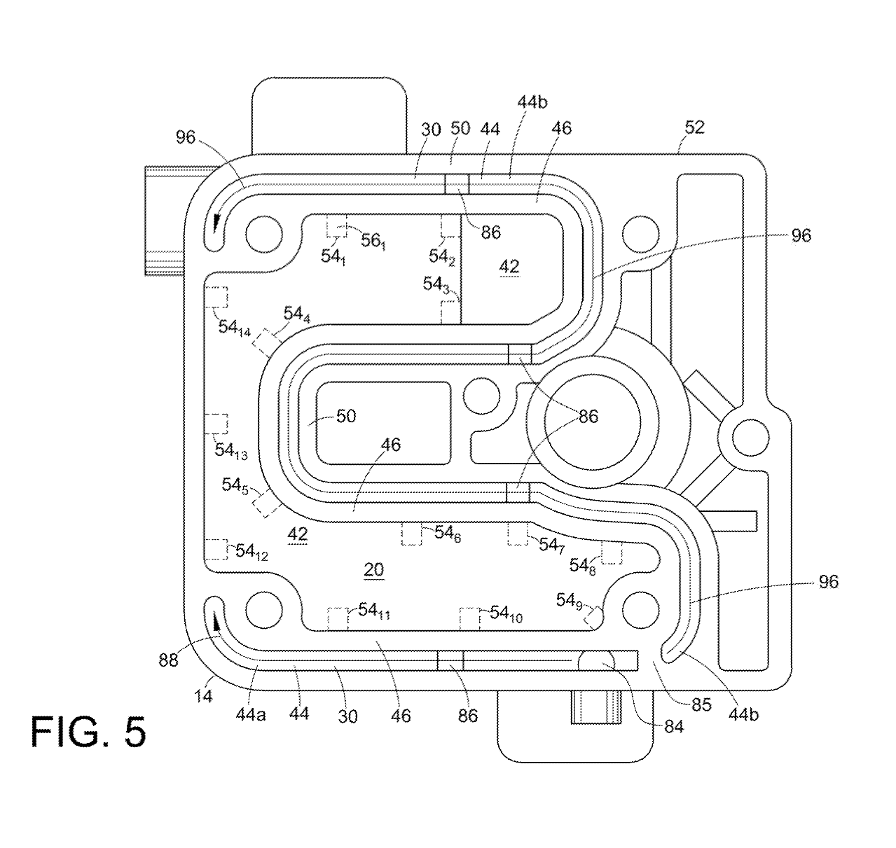

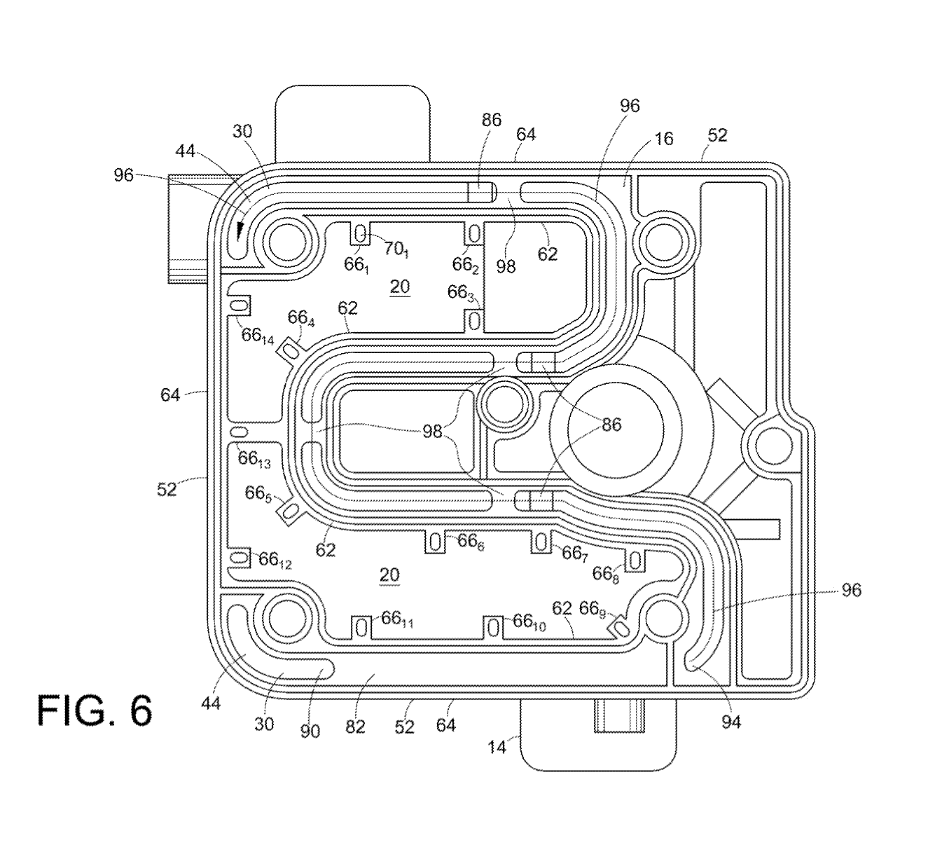

With reference to the embodiment illustrated in FIG. 5, the baffle 20 is a relatively U-shaped, thin metallic piece that fits on the lower ledges 54 (shown as dashed lines in FIG. 5) before the gasket 16 (see FIG. 6) is installed. However, it is contemplated that the baffle 20 may be essentially any shape that follows the shape of the second volume 30. For example, instead of being U-shaped, it is also contemplated that the baffle 20 may be oblong and/or rectangular shaped. The baffle 20 is used to increase the discharge air velocity through compressor head 10 to improve cooling.

With reference to FIG. 6, the gasket 16 is positioned on top of the baffle 20. The illustrated baffle 20 does not require additional assembly steps to fasten the baffle 20 to the lower portion 14 of the compressor head 10 (see FIG. 1). Instead, as discussed in more detail below, the air baffle 20 is held in place by at least one tab 66 of the gasket 16, the upper ledges 40 (see FIG. 3) and the lower ledges 54 (see FIG. 4).

The gasket 16 includes an inner perimeter portion 62 and an outer perimeter portion 64. In one embodiment, the gasket 16 is a rubber coated steel material. The rubber coating provides a sealing surface while the steel material provides strength.

With reference to FIGS. 2, 3, and 6, when assembled, the inner perimeter portion 62 is between the upper inner mating portion 32 and the lower inner mating portion 46 of the compressor head 10. In addition, the inner perimeter portion 62 substantially delineates the upper inner mating portion 32 and the lower inner mating portion 46 of the compressor head 10. In other words, the inner perimeter portion 62 substantially follows a path defined by both the upper inner mating portion 32 and the lower inner mating portion 46. Since the gasket 16 acts as a sealing device, the inner perimeter portion 62 provides a seal between the upper inner mating portion 32 and the lower inner mating portion 46 of the compressor head 10. Therefore, the inner perimeter portion 62 of the gasket 16 provides a seal between the first and second volumes 24, 30 along the paths defined by both the upper inner mating portion 32 and the lower inner mating portion 46 of the compressor head 10.

The outer perimeter portion 64 is between the upper outer mating portion 34 and the lower outer mating portion 50 of the compressor head 10. In addition, the outer perimeter portion 64 substantially delineates the upper outer mating portion 34 and the lower outer mating portion 50 of the compressor head 10. In other words, the outer perimeter portion 64 substantially follows a path defined by both the upper outer mating portion 34 and the lower outer mating portion 50. Since the gasket 16 acts as a sealing device, the outer perimeter portion 64 provides a seal between the upper outer mating portion 34 and the lower outer mating portion 50 of the compressor head 10. Therefore, the outer perimeter portion 64 of the gasket 16 provides a seal between the second volume 30 and atmosphere along the path defined by the upper outer mating portion 34 and the lower outer mating portion 50 of the compressor head 10. The gasket 16 also provides a seal between the upper outer perimeter 36 of the upper portion 12 and the lower outer perimeter 52 of the lower portion 14.

The at least one tab 66 extends toward (e.g., into) the first volume 24 from the inner perimeter portion 62 of the gasket 16. In the illustrated embodiment, the gasket 16 includes fourteen (14) tabs 66₁, 66₂, 66₃, 66₄, 66₅, 66₆, 66₇, 66₈, 66₉, 66₁₀, 66₁₁, 66₁₂, 66₁₃, 66₁₄ (collectively 66). The at least one tab 66 is substantially aligned with both the respective faces 60 of the at least one upper ledge 40 and the respective faces 56 of the at least one lower ledge 54 when the upper portion 12 is aligned with the lower portion 14. For example, the tab 66₁ is substantially aligned with both the respective face 60₁ of the at least one upper ledge 40₁ and the respective face 56₁ of the at least one lower ledge 54₁ when the upper portion 12 is aligned with the lower portion 14.

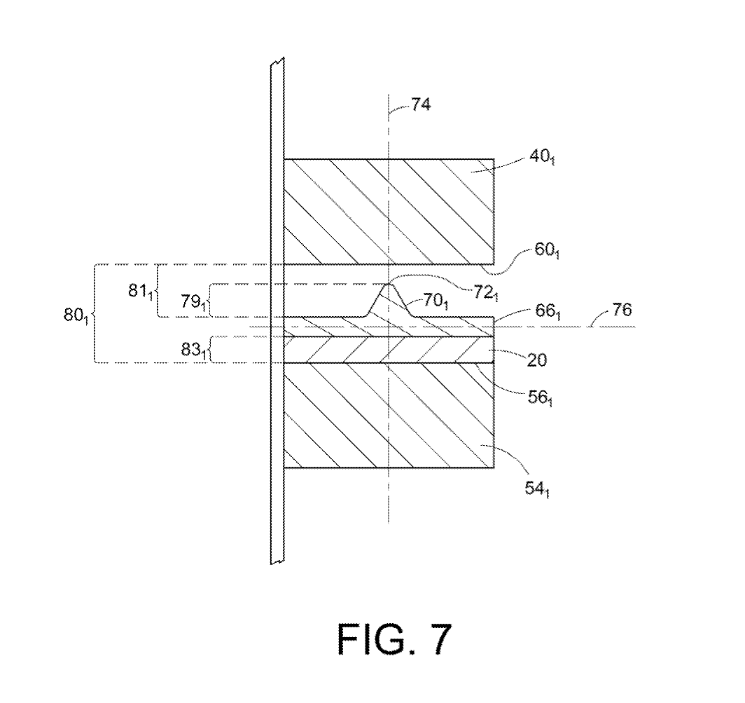

With reference to FIGS. 6 and 7, respective projections 70 (e.g., beads) are included on at least one of the tabs 66. Although each of the tabs 66 includes a respective one of the projections 70, only one of the projections 70₁ (see FIG. 6) is shown for ease of illustration. The at least one projection 70₁ extends (protrudes) in a direction such that a top 72 of the projection 70 is along a projection axis 74 (plane) that is generally perpendicular to a face 76 (plane) that is substantially parallel to the respective tab 66. In other words, the at least one projection 70 extends toward at least one of the respective faces 60 of the at least one upper ledge 40 and the respective faces 56 of the at least one lower ledge 54 when the upper portion 12 and the lower portion 14 of the compressor head 10 are matingly assembled and secured together. In the illustrated embodiment, the at least one projection 70₁ extends toward the face 60₁ of the at least one upper ledge 40₁. The length (circumference) of the projections 70 can also be modified to assist in vibration damping.

A height 79₁ (e.g., an original height) of the at least one projection 70₁ along the projection axis 74 is based on a maximum expected force to be exerted on the baffle 20. In one embodiment, the original height 79₁ along the projection axis 74 is about 1/3 more than a distance 80₁ between the respective faces 60₁ of the at least one upper ledge 40₁ and the respective faces 56₁ of the at least one lower ledge 54₁, plus a maximum possible gap 81₁, and less a thickness 83₁ of the baffle 20, considering the respective tolerances of the distance 80₁, the gap 81₁, and/or the thickness 83₁ when the upper portion 12 and the lower portion 14 of the compressor head 10 are matingly assembled and secured together.

With reference to FIGS. 2, 3, 6, and 7, as the compressor head 10 is assembled, the upper portion 12 and the lower portion 14 are matingly secured together so that the respective faces 60 of the at least one upper ledge 40 and the respective faces 56 of the at least one lower ledge 54 are aligned. The gasket 16 is positioned between the upper portion 12 and the lower portion 14. Also, as noted above, the baffle 20 is between the lower ledges 54 of the lower portion 14 and the gasket 16. When the upper portion 12 and lower portion 14 of the compressor head 10 are aligned and urged toward each other, with the gasket 16 and baffle 20 in between, the baffle 20 and the respective faces 56 of the at least one lower ledge 54 frictionally engage and at least partially flatten the respective at least one projection 70. In one embodiment, the at least one projection 70 is flattened to a flattened height, which is about 1/3 of the original height between the baffle 20 and the at least one lower ledge 54.

The at least one flattened projection 70 does not extend into the first volume 24. More specifically, the at least one flattened projection 70 does not extend beyond the edges of the respective faces 60 of the at least one upper ledge 40 and the respective faces 56 of the at least one lower ledge 54. In other words, a surface area covered by the at least one partially flattened projection 70 is less than a surface area of the respective faces 60 of the at least one upper ledge 40; and the surface area covered by the at least partially flattened projection 70 is less than a surface area of the respective faces 56 of the at least one lower ledge 54.

The at least one tab 66 cooperates with the faces 56 of the at least one lower ledge 54 and the baffle 20 to reduce vibration of the baffle 20 between the upper portion 12 and the lower portion 14 of the compressor head 10. In one embodiment, the cooperation of the projection 70 of the at least one tab 66 with the at least one lower ledge 54 and the baffle 20 acts to frictionally secure the baffle 20 between the upper portion 12 and the lower portion 14 to reduce vibration as air flows through the first volume 24 of the compressor head 10. In the illustrated embodiment, the at least one projection 70 and the at least one tab 66 of the gasket 16 act as a means to reduce vibration of the baffle 20 between the upper portion 12 and the lower portion 14 of the compressor head 10. In the illustrated embodiment, the means to reduce vibration of the baffle 20 between the upper portion 12 and the lower portion 14 of the compressor head 10 is integrated with the inner perimeter portion 62 of the gasket 16. Also, the at least one projection 70 and the at least one tab 66 of the gasket 16 act as a vibration reduction member of the baffle 20. Other means to reduce vibration of the baffle could be a continuous bead in the gasket, a spring loaded mechanism in addition to the gasket, a projection on the upper head to mate with baffle etc.

With reference to FIGS. 3, 4, and 6, in one embodiment, a webbing portion 82 of the gasket 16 is provided in at least a portion of the second volume 30 of the compressor head 10. The webbing portion 82 divides at least a portion of the second volume 30 adjacent an inlet port 84 of the compressor head 10. In the illustrated embodiment, the inlet port 84 is included in the lower portion 14 of the head 10. A wall 85 separates the lower portion 44 of the second volume 30 into two (2) fluidly independent first and second lower sections 44a, 44b, respectively. More specifically, when the gasket 16 is positioned on the lower portion 14 of the compressor head 10 (see FIG. 6), the wall 85 cooperates with the webbing portion 82 to substantially prevent fluid being communicated between the first and second lower sections 44a, 44b of the second volume 30. It is noted fluid freely flows by support structures 86 in the first and second lower sections 44a, 44b of the second volume 30. Therefore, while the wall 85 acts to substantially block fluid from being communicated between the first and second lower sections 44a, 44b of the second volume 30, the support structures 86 in the second lower section 44b of the second volume 30 allow fluid to freely move within the second lower section 44b of the second volume 30.

Because of the cooperation of the webbing portion 82 with the wall 85, fluid (e.g., coolant and/or water) entering the inlet port 84 in the lower portion 14 of the compressor head 10 is initially maintained in the first lower section 44a of the second volume 30 in the lower portion 14 of the compressor head 10. More specifically, the fluid entering the inlet port 84 is directed by at least one of the wall 85 and the webbing portion 82 to flow along a path 88 in the first lower section 44a of the second volume 30. Upon reaching a first opening 90 in the gasket 16 between the inner perimeter portion 62 and the outer perimeter portion 64 of the gasket 16, the fluid passes through the first opening 90 and into the upper portion 26 of the second volume 30. Once in the upper portion 26 of the second volume 30, the fluid travels along a path 92 in the upper portion 26 of the second volume 30 along the webbing portion 82. After the fluid reaches the end of the webbing portion 82 and has passed over the wall 85 in the lower section 44 of the second volume 30, the fluid reaches a second opening 94 in the gasket 16 between the inner perimeter portion 62 and the outer perimeter portion 64 of the gasket 16. Upon reaching the second opening 94 in the gasket 16, the fluid continues to freely flow in the upper portion 26 of the second volume 30 and is also free to flow in the second lower section 44b of the second volume 30. At this point, since the fluid can freely pass (e.g., mix) between the upper portion 26 of the second volume 30 and the second lower section 44b of the second volume 30, the fluid is illustrated as following a path 96 in the upper portion 26 of the second volume 30 and the second lower section 44b of the second volume 30. The fluid flows along the path 96 until reaching a fluid outlet port 97 of the compressor head 10. The fluid may exit the compressor head 10 via the fluid outlet port 97. It is to be understood that gasket support structures 98 between the inner perimeter portion 62 and the outer perimeter portion 64 do not significantly extend into either the upper portion 26 of the second volume 30 or the second lower section 44b of the second volume 30 and, therefore, do not obstruct the fluid flowing along the path 96.

Since the compressor head 10 is typically at elevated temperatures (e.g., >˜300° F.), maintaining the fluid (e.g., coolant and/or water) in the lower portion 14 of the compressor head 10 for at least the length of the webbing portion 82 and then in the upper portion 12 of the compressor head 10 for at least the length of the webbing portion 82 helps prevent the fluid (e.g., coolant and/or water) vaporizing (e.g., burning off). More specifically, if the fluid (e.g., coolant and/or water) enters the compressor head 10 and touches an inside wall of the compressor head 10 that is substantially dry, the fluid (e.g., coolant and/or water) may vaporize. Providing the webbing portion 82 adjacent the inlet port 84 initially restricts (e.g., maintains) the fluid (e.g., coolant and/or water) in a smaller volume (e.g., the first lower section 44a of the second volume 30 as opposed to the entire second volume 30 and then the upper portion 26 of the second volume 30 along the webbing portion 82 as opposed to the entire second volume 30) to help avoid dry areas from forming on the inner wall of the second volume 30 of the compressor head 10 and, furthermore, to help avoid the fluid (e.g., coolant and/or water) from vaporizing when entering the compressor head 10. In addition, the webbing portion 82 acts to increase coolant and/or water velocity, provide more uniform coolant and/or water flow, and reduce low heat transfer area for coolant and/or water flow.

The webbing portion 82 acts as a means for directing the fluid (e.g., coolant and/or water) passing through the second volume 30, increasing coolant and/or water velocity, providing more uniform coolant and/or water flow, and reducing low heat transfer area for coolant and/or water flow. In the illustrated embodiment, the webbing portion 82 extends along only a portion of the second volume 30. However, other embodiments in which the webbing portion 82 extends almost substantially the entire second volume 30 are also contemplated.

As illustrated, the webbing portion 82 is integrated between the inner perimeter portion 62 and the outer perimeter portion 64 of the gasket 16.

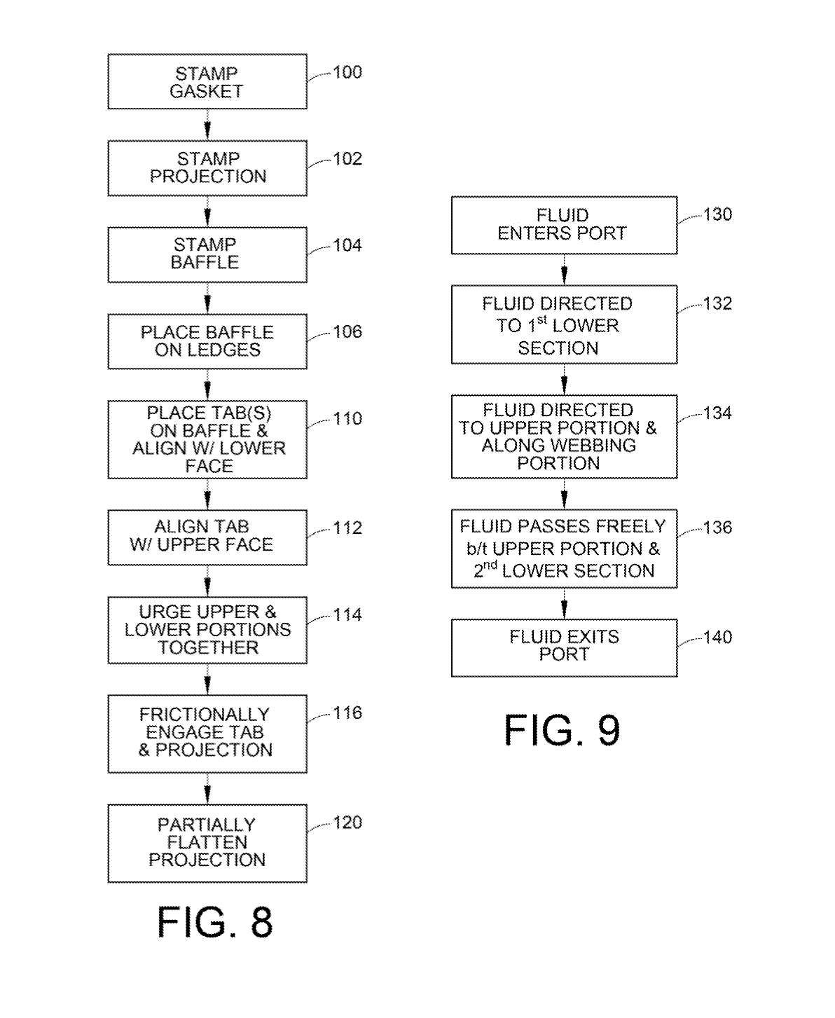

With reference to FIG. 8, an exemplary methodology of manufacturing the compressor head 10 shown in FIGS. 1-7 is illustrated. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 1-8, the gasket 16 is stamped in a step 100. The stamping in the step 100 includes creating the webbing portion 82 as integral with the gasket 16. In a step 102, the at least one projection 70 is stamped into the gasket 16. The step 102 includes sizing the original height of the projection 70 so that the projection 70 is flattened to about ⅓ of the original height in a later step when the upper portion 12 and the lower portion 14 are urged together. In a step 104, the baffle 20 is stamped.

In a step 106, the baffle 20 is placed on the lower ledges 54. In a step 110, the tab(s) 66 extending from the inner perimeter portion 62 of the gasket 16 are placed on top of the baffle 20 and aligned with the lower face 56 of the lower ledge 54. Then, in a step 112, the tab 66 is aligned with the other of the upper face 60 of the upper ledge 40 and the lower face 56 of the lower ledge 54.

Then, in a step 114, the upper portion 12 of the compressor head 10 and the lower portion 14 of the compressor head 10 are urged together. As the upper portion 12 and the lower portion 14 are urged together, the tab 66 frictionally engages the baffle 20 and the at least one upper face 60 of the upper ledge 40, and the projection 70 frictionally engages the at least one upper face 60 of the upper ledge 40 in a step 116. The projection 70 is at least partially flattened between the baffle 20 and the upper face 60 of the upper ledge 40 in a step 120.

With reference to FIG. 9, an exemplary methodology of passing fluid through the second volume 30 of the compressor head 10 shown in FIGS. 1-7 is illustrated. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 1-7 and 9, in a step 130, the fluid (e.g., coolant and/or water) enters the inlet port 84 of the compressor head 10. In a step 132, the fluid is directed by the webbing portion 82 of the gasket 16 into the first lower section 44a of the second volume 30. In a step 134, the fluid passes (e.g., is directed) from the first lower section 44a of the second volume 30 to the upper portion 26 of the second volume 30 and then passes along the webbing portion 82. Then, in a step 136, the fluid passes freely (e.g., mixes) between the upper portion 26 of the second volume 30 and the second lower section 44b of the second volume 30 after traveling the length of the webbing portion 82. The fluid then exits the outlet port 97 of the compressor head 10 in a step 140.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A gasket, comprising:
an outer perimeter portion between an upper portion of an associated compressor head and a lower portion of the associated compressor head, the outer perimeter portion substantially delineating respective outer mating portions of the upper and lower portions of the associated compressor head;
an inner perimeter portion substantially delineating respective first inner mating portions of the upper and lower portions of the associated compressor head defining a first volume; and
a tab extending toward the first volume from the inner perimeter portion, the tab substantially aligning with both an upper ledge of the upper portion of the associated compressor head and a lower ledge of the lower portion of the associated compressor head.

2. The gasket as set forth in claim 1, wherein:
a webbing portion within a second volume defined by the upper and lower portions of the associated compressor head.

3. The gasket as set forth in claim 2, wherein:
the webbing portion directs fluid entering an inlet port to be initially restricted to the lower portion of the associated compressor head.

4. The gasket as set forth in claim 1, further including:
a projection extending toward at least one of the upper ledge and the lower ledge.

5. The gasket as set forth in claim 4, wherein:
the projection is at least partially flattened between the upper ledge and an associated baffle when the upper portion of the compressor head is matingly secured with the lower portion of the compressor head.

6. The gasket as set forth in claim 5, wherein:
the projection cooperates with the upper ledge, the associated baffle, and a lower ledge to reduce vibration of the baffle when fluid flows in the first volume.

7. The gasket as set forth in claim 5, wherein:
the projection is flattened to about ⅓ of an original height of the projection.

8. The gasket as set forth in claim 7, wherein:
the original height of the projection is about ⅓ more than a distance between the upper ledge and the lower ledge less a thickness of the associated baffle.

9. The gasket as set forth in claim 5, wherein:
the projection engages the upper ledge; and
a surface area covered by the at least partially flattened projection is less than a surface area of a face of the upper ledge that contacts the projection.

10. The gasket as set forth in claim 9, wherein:
the at least partially flattened projection does not extend beyond the upper ledge into the first volume.

11. The gasket as set forth in claim 5, wherein:
an original height of the projection is based on a maximum expected force to be exerted on the inner perimeter portion.

12. The gasket as set forth in claim 1, further including:
a rubber coated steel material.

13. A compressor head, comprising:
an upper part, including:
an upper portion of a first volume;
an upper ledge in the first volume; and
an upper portion of a second volume;
a lower part, including:
a lower portion of the first volume;
a lower ledge, substantially aligned with the upper ledge, in the first volume; and
a lower portion of the second volume;
an upper inner mating portion defining the upper portion of the first volume and the upper portion of the second volume;
a lower inner mating portion defining the lower portion of the first volume and the lower portion of the second volume;
an upper outer mating portion defining the upper portion of the second volume;
a lower outer mating portion defining the lower portion of the second volume;
a baffle;
a gasket between the upper portion and the baffle, the gasket including:
an inner perimeter portion between, and substantially delineating, the upper inner mating portion and the lower inner mating portion;
an outer perimeter portion between, and substantially delineating, the upper outer mating portion and the lower outer mating portion; and
a tab, extending toward the first volume from the inner perimeter portion, cooperating with the upper ledge, the baffle, and the lower ledge to reduce vibration of the baffle between the upper part and the lower part.

14. The compressor head as set forth in claim 13, wherein:
the baffle is substantially U-shaped.

15. The compressor head as set forth in claim 13, wherein:
the upper outer mating portion is proximate to an upper outer perimeter of the upper portion; and
the lower outer mating portion is proximate to a lower outer perimeter of the lower portion.

16. The compressor head as set forth in claim 13, wherein the gasket further includes:
a webbing portion directing fluid entering the second volume to be initially restricted to a lower portion of the second volume.

17. The compressor head as set forth in claim 16, wherein:
the webbing is integrated between the inner perimeter portion and the outer portion.

18. The compressor head as set forth in claim 13, wherein:
the tab is substantially aligned with both the upper ledge and the lower ledge.

19. The compressor head as set forth in claim 13, the tab including:
a projection between the upper ledge and the baffle.

20. The compressor head as set forth in claim 19, wherein:
the projection cooperates with the upper ledge and the baffle to secure the baffle between the upper part and the lower part.

21. The compressor head as set forth in claim 20, wherein:
the projection is frictionally secured between the upper ledge of the upper part and the baffle; and
the securement of the gasket between the upper ledge and the baffle reduces vibration of the baffle when fluid flows in the first volume.

22. The compressor head as set forth in claim 21, wherein:
the projection is at least partially flattened between the upper ledge and the baffle; and
a surface area of the at least partially flattened projection is less than a surface area of a face of the upper ledge that contacts the projection.

23. A compressor head, comprising:
an upper part, including:
an upper portion of a first volume; and
an upper portion of a second volume;
a lower part, including:
a lower portion of the first volume; and
a lower portion of the second volume;
a sealing device between the upper part and the lower part;
a baffle between the upper part and the lower part; and
means for reducing vibration of the baffle between the upper part and the lower part.

24. The compressor head as set forth in claim 23, wherein:
the upper part includes an upper ledge in the first volume;
the lower part includes a lower ledge in the first volume; and
the means for reducing vibration is secured between the upper ledge and the baffle.

25. The compressor head as set forth in claim 24, further including:
an upper inner mating portion defining the upper portion of the first volume and the upper portion of the second volume; and
a lower inner mating portion defining the lower portion of the first volume and the lower portion of the second volume;
wherein the sealing device includes:
an inner perimeter portion between, and substantially delineating, the upper inner mating portion and the lower inner mating portion; and
the means for reducing vibration of the baffle that extends toward the first volume from the inner perimeter portion.

26. The compressor head as set forth in claim 25, wherein:
the means for reducing vibration extends from the inner perimeter portion and is engaged between the upper ledge and the lower ledge.

27. The compressor head as set forth in claim 23, the sealing device includes:
means for directing fluid passing into the second volume to be initially restricted to one of the portions of the compressor head.

28. The compressor head as set forth in claim 27, further including:
an upper outer mating portion defining the upper portion of the second volume; and
a lower outer mating portion defining the lower portion of the second volume;
wherein the sealing device includes an outer perimeter portion between, and substantially delineating, the upper outer mating portion and the lower outer mating portion; and
wherein the means for directing fluid is integrated with the outer perimeter portion of the sealing device.

29. A gasket, comprising:
an outer perimeter portion between an upper portion of an associated compressor head and a lower portion of the associated compressor head, the outer perimeter portion substantially delineating respective outer mating portions of the upper and lower portions of the associated compressor head;
an inner perimeter portion substantially delineating respective first inner mating portions of the upper and lower portions of the associated compressor head defining a first volume;
a webbing portion between the outer perimeter portion and the inner perimeter portion; and
a vibration reduction member secured between the upper portion of the associated compressor head, a baffle, and the lower portion of the associated compressor head and extending into the first volume.

30. The gasket as set forth in claim 29, wherein:
the vibration reduction member extends from the inner perimeter portion into the first volume along a first plane;
the vibration reduction member includes a projection extending along a second plane substantially perpendicular to the first plane; and
the projection engages, and is deformed by, the upper portion of the associated compressor head and the baffle.

31. The gasket as set forth in claim 30, wherein:
the engagement of the deformed projection reduces vibration of the baffle as fluid flows through the first volume.
